(19) United States
(12) Patent Application Publication
(10) Pub. No.: US 2010/0179861 A1
(43) Pub. Date: Jul. 15, 2010

(54) SYSTEM AND METHOD FOR ASSESSING AND MANAGING OBJECTS

(75) Inventors: Mikael Teerilahti, Espoo (FI); Markus Halonen, Tuusula (FI); Risto Teerilahti, Helsinki (FI); Samuli Teerilahti, Espoo (FI); Teppo Teerilahti, Tampere (FI); Esa Heimo, Espoo (FI); Arto Ojala, Helsinki (FI)

Correspondence Address: YOUNG & THOMPSON, 209 Madison Street, Suite 500, Alexandria, VA, 22314, US

(73) Assignee: GREY-HEN OY, Espoo (FI)

(21) Appl. No.: 12/602,244

(22) PCT Filed: Feb. 1, 2008
(86) PCT No.: PCT/FI2008/050039

§ 371 Date: Nov. 30, 2009

(30) Foreign Application Priority Data
May 31, 2007 (FI) PCT FI2007 000150

(51) Int. Cl. G06Q 10/00; G06Q 30/00; G06Q 99/00; G06Q 50/00

(52) U.S. Cl. 705/10; 705/7; 705/27; 705/306; 705/348

(57) ABSTRACT

System and method for assessing objects such as vehicles, wherein a value estimation model is determined for vehicles on a basis of data representing characteristics of a plurality of vehicles, the model including a plurality of parameters to be determined and a plurality of explanatory variables associated with the parameters and defined on the basis of the characteristics, wherein age and/or mileage of vehicles is configured to affect the value estimate, the value estimate being a dependent variable in the model, and wherein a unit for producing a value estimate for a target vehicle on the basis of the model is configured to perform an action (508, 510, 512, 513, 518, 524, 604, 710) to facilitate comparison of the value estimate to other valuation information related to the particular target vehicle or some other vehicle.

### FIELD OF THE INVENTION

Generally the invention pertains to evaluating characteristics of various objects. Particularly the invention concerns provision of comparison and other analysis information relating to the estimated value of target object(s) on the basis of the evaluation results and performing related actions.

### BACKGROUND OF THE INVENTION

Traditionally, business-wise successful trade of second-hand commodities such as pre-owned vehicles (cars, motorbikes, etc) has been a business of highly-trained and experienced individuals, i.e. “experts”, who have assessed running price (sales and/or purchase) of the products by mainly relying on their cultivated perception and instinct, i.e. mental arithmetics. Additionally, some relatively simple statistic tools such as calculating a price average from available data including sales catalogues and various advertisements have been utilized as a pricing basis in the decision-making process.

Reverting to the trade of pre-owned cars, for example, if second-hand products were as homogenous as new ones with only a few dynamic characteristics such as age having an effect in the running value, purely intellectual or manual pricing thereof would not necessarily cause insuperable problems. However, in reality the pre-owned cars are associated with a great number of price-affecting variables, the values of which can be either of categorizing (e.g. brand, model) or continuous type (distance driven or “mileage” (despite of the term, can in the context of the present invention be given in kilometres or other preferred alternative units), and age, even if modeled as mere “model year”), for example.

One could estimate the overall number of different types of cars (an exemplary nationwide car type register may contain tens of thousands of different type approvals, for example), which is in most market areas quite considerable. Further, various variables in addition to the type information may indicate the presence of different equipment such as air-con or alloy wheels, engine size, maximum horsepower/torque, consumption figures, trunk space, number of doors and/or seats, etc. Thus, one may fairly state that each article on sale is a unique entity keeping also the distance driven and age in mind.

These factors result in scenarios wherein a salesman or a buyer seldom has enough comparison data available for estimating the value of an object in order to either price the object or evaluate the asking price, respectively. Especially from the standpoint of the buyer, as the objects available for sale are not fully homogenous, it is hard to assess the validity of price requests, i.e. which objects are actually cheap and which are more expensive. In addition to objective specifications reflected by the above variable values, there are number of factors that are hard or practically impossible to represent parametrically, said factors including the overall condition of the object (e.g. in relation to cars, condition of paint work, windshield, dampers, and springs, number and nature of dents, interior wear, engine leaks, etc). In case there are two parametrically quite comparable objects available for sale but the prices differ, one could legitimately expect that the more pricey one is either in better shape or the seller just wants more money from it. Alternatively, the seller of a more expensive product may offer additional services not provided by other sellers. Thus, in market economy even homogenous products differ in price; such difference may be produced by factors that cannot be or at least, are not, parameterized, e.g. unknown and random factors (results of expert evaluations, etc).

Some computerized sales services that are accessible through the Internet, for example, comprise a database wherein details such as the aforesaid variable values of the individual sales objects of multiple sellers are stored. User of the system may then execute searches in the database on the basis of available search terms that are defined via desired variable values and value ranges, for example. The system finally returns the sales objects that fulfill the conditions set by the user. The user may manually investigate the retrieved price requests and try to figure out why these differ between each object, although each object has fulfilled the initial search criteria. The user may also exploit this arrangement for pricing his own article he is willing to place for sale by calculating an average price from the returned data and adjusting the sales price of his article subjectively based on that, for example; if the user is of the opinion that his article is in exceptionally good condition, he may set the price above the average and vice versa. However, this kind of pricing method is not accurate as the user has to, in practice, extrapolate and thus mentally model a running value for his article on the basis of known articles and their specifications and price requests. This kind of mental modelling may not be possible, especially when there are a lot of data and parameters. The effect the individual variables eventually have in the prices is likewise very hard to estimate on the basis of such database arrangements, not forgetting the fact that some variables may have a dependency between them in so far as the sales value of the article is in question.

Contemporary computerized systems such as the ones described above are used both by dealers and private users for assessing objects in the context of purchase or sale contemplations.

Particularly in vehicle trade the effect of mileage is alluring to model in an oversimplified manner, e.g. as a straight line in a graphical representation where the distance driven is shown on one axis and price reduction on another. Further, the territorial effect, i.e. where the object is offered for sale geographically, is typically omitted from modeling; all the data in the database (concerning e.g. a single country) is just equally considered. Accordingly, even the same object may be of different value to different entities such as dealers, wholesale dealers, or chains, based on geographic, client (private or wholesale, etc) or other business-related factors, which is an issue that is not perceptible neither taken into account by conventional computerised sales or analysis systems.

Yet, in computerized solutions where the amount of available source data is massive, e.g. a nationwide database, the tendency is to cut most of the data straight away from slowing down the real-time analysis while determining a price estimate for a certain type of an object. This may certainly reduce the processing requirements but at the same time the precision of results may decrease as a major part of data initially available for analysis is filtered out. For example, if the user is solely interested in purchasing, selling or maybe just assessing one particular car model (“model” defined according to the utilized vehicle type/model system, for example) with certain age and kilometer specifications, the system may simply filter out the data not fulfilling the criteria (i.e. not falling within the desired parameter range) and then determine basic characteristics such as average or standard deviation from the asking prices of the remaining database objects. To the contrary, expert evaluation may actually offer more accurate results than oversimplified computerized modeling, however at the cost of processing delay, which may in the case of a single expert or an expert council extend over several days.

One more issue frequently popping up in the context of computerized solutions is the presence of erroneous information (e.g. wrong parameters) in the database information due to e.g. typing errors introduced during the information input process. If this erroneous information is taken into account upon determining indications of a presumed value of a certain-type object and the total number of objects used in the evaluation is low, the erroneous information may dramatically reduce the precision of the assessment.

Notwithstanding the existence of tools for assisting a product dealer or a buyer with object value evaluations, the current computerized solutions are either extremely simple and cursory, thus omitting many factors that in reality affect the value, or are exhaustively based on personal knowledge and thus also bias of certain experts, which make the analysis generally inaccurate and in the latter case, also time-consuming.

### SUMMARY OF THE INVENTION

The objective is to provide an arrangement for alleviating at least some of the deficiencies present in various prior art solutions reviewed above. The objective is achieved via a system and a method in accordance with the present invention.

According to an aspect of the invention a computerized system for assessing and optionally managing vehicles comprises

means for obtaining data, optionally from a plurality of sources, said data representing characteristics of a plurality of vehicles, said data including indication of a value of each vehicle and of at least one characteristic selected from the group consisting of: age and mileage of the vehicle,
means for storing said received data,
means for receiving a request for a value estimate of at least one target vehicle having a number of predetermined characteristics,
means for producing a value estimate for said at least one target vehicle on the basis of the data, characterized by
means for determining a value estimation model for vehicles on the basis of the received data representing characteristics of a plurality of vehicles, said model comprising a plurality of parameters to be determined and a plurality of explanatory variables associated with the parameters and defined on the basis of said characteristics, wherein at least one of said age and mileage is configured to affect the value estimate, the value estimate being a dependent variable in the model,
means for storing at least part of the value estimation model including said plurality of parameters modeled, whereby, in order to serve valuation requests said means for producing the value estimate is configured to map at least part of said number of predetermined characteristics of said at least one target vehicle, via said value estimation model, to said value estimate,
wherein said system, such as the means for producing the value estimate, is configured to perform an action to facilitate comparison of the value estimate to other valuation information related to said at least one target vehicle or some other vehicle.

The aforesaid means for storing, producing, and determining may be integrated or physically separate but still functionally connected entities, e.g. computer network entities such as server(s) or terminal(s), having a communications connection arrangeable between them. The same applies to internal functions of a single means; they may be physically separated between a plurality of entities but the aggregate entity comprising them may be considered as a functional means.

According to another aspect of the invention a method for assessing vehicles comprises

obtaining data, optionally from a plurality of sources, said data representing characteristics of a plurality of vehicles, said data including indication of a value of each vehicle and of at least one characteristic selected from the group consisting of: age and mileage of the vehicle,
storing said received data in a first storage,
receiving a request for a value estimate of at least one target vehicle having a number of predetermined characteristics, and
producing a value estimate for said at least one target vehicle on the basis of the data, characterized by
determining a value estimation model for vehicles on the basis of the received data, said model comprising a plurality of parameters to be determined and a plurality of explanatory variables associated with the parameters and defined on the basis of said characteristics, wherein at least one of said age and mileage affect the value estimate, the value estimate being a dependent variable in the model,
storing at least part of the value estimation model including said plurality of parameters modelled in a second storage, and, in response to receiving the request,
mapping at least part of said number of predetermined characteristics of the target vehicle, via said value estimation model, to said value estimate, wherein an action to facilitate comparison of the value estimate to other valuation information related to said at least one target vehicle or some other vehicle is performed.

In an embodiment, age and mileage jointly affect the value estimate.

In a further embodiment, the first and second storages refer to first and second entities such as databases, respectively. In another embodiment, the first and second storages refer to physically and/or logically different memory locations of one or more memory entities.

In one embodiment, said data also include indication of a location of each vehicle, whereby the location is configured to affect the value estimate, via the value estimation model, as an explanatory variable and/or as a part of a joint (interactive) variable defined by a plurality of characteristics and/or other preferred factors.

The utility of the present invention arises from multiple issues. One embodiment of the invention facilitates comparing price instances of various second-hand vehicle entities, e.g. asking or sales prices, with statistically produced value estimates. Also general price levels of various entities such as different car dealers or dealer chains may be compared with each other.

Some embodiments of the invention provide a tool for handling transfers of in-stock vehicles between different outlets of a dealer (chain) such that the overall profit is maximized.

Another embodiment facilitates focusing marketing efforts towards parties the current vehicles of which are particularly appealing as trade-in items.

An embodiment of the present invention enables modeling the (value) effect of desired characteristics, e.g. distance driven or age, with different modelling accuracy. It may be computationally efficient to model certain characteristics in a more coarse manner, i.e. concerning a larger group of vehicles (e.g. certain vehicle types of a certain vehicle model, certain brands, certain engine types, etc) at time, whereas some other characteristics shall be modelled more independently.

Further, an embodiment of the present invention advantageously enables constructing only a single value estimation model via which value estimates of a plurality of different vehicle types, e.g. car types according to a predetermined classification system, can be modelled instead of dividing the whole vehicle type population into more homogenous subsets that are independently modelled via a plurality of models. The present invention thus provides a function that maps various characteristics of a vehicle to a value estimate.

In one embodiment of the invention, available vehicle type register (e.g. a classification database of vehicles into homogenous subsets according to predetermined rules) can be used to supplement and/or correct the value information, e.g. realized sales or asking price, provided by the rest of the sources in relation to the vehicles. It may happen that the sources, e.g. car dealers, provide information that is either erroneous, inaccurate, or otherwise deficient. If such imperfect information is combined with the information present in the type register, data in the first storage can be verified upon input or afterwards. In that sense the input data to be stored in the first storage may initially reside as fragmented in multiple locations.

Still, in one embodiment the arrangement of the present invention provides reliable value estimations for target vehicles the types of which may be present in the available type register but for which real-life findings have been insufficient or non-existent. The present invention may be used to interpolate (or extrapolate, in certain occasions) the effect of various characteristics of the target vehicle in the value estimate based on the corresponding effect of the neighbouring types having more modelling data available.

Various embodiments of the invention for gathering data from a plurality of sources for estimating parameters of a value estimation model for articles such as pre-owned vehicles is more precise than previous models due to taking e.g. the regional effect into account together with mileage and/or age. Further synergy benefit is obtained when the raw data gathered from the plurality of sources is translated, for example periodically, into the model capitalizing e.g. the regional effect so that the model can be kept detailed and accurate without adding to the response time upon receiving a service request from a user for obtaining a value estimate for a specific vehicle.

In various further embodiments, the resulting estimation result can be obtained relatively fast, e.g. in a few seconds. This is mainly due to the predetermined or precalculated model parameters that enable utilizing and/or depicting the model via expectation value surfaces in relation to the model variables. The estimation can be determined on a montly, weekly or daily basis for each object; for example, a retailer having a plurality of pre-owned cars in stock can enter details of the cars into the system and update the information in case of changes, whereupon the system automatically, e.g. once a week on the basis of updated sample data, or in response to an update request, (re)calculates the parameters of an empirical model describing the relationships between the predetermined dependent and explanatory variables thereof.

Yet, in various embodiments of the invention the user may relatively easily detect significant price deviations. For example, the user can notice whether the true asking price of a target vehicle is exceptionally high or low based on comparison with a purely mathematical value estimate obtained by the model. This phenomenon could be illustrated as an isolated point located far away from the corresponding expectation value surface as defined by the model. The expectation value surfaces provided by the model thus effectively filter out indiscriminate noise from the data.

In a certain embodiment of the present invention the modelling solution of the invention is specifically tailored for estimating running value, e.g. asking or sales price, of pre-owned vehicles such as cars. Also regional price differences are taken into account in the model.

### BRIEF DESCRIPTION OF THE RELATED DRAWINGS

Below, the embodiments of the invention are described in more detail with reference to the attached drawings in which:

FIG. 1 illustrates one embodiment of a system according to the invention.

FIG. 2 is one example of a feasible visualization of an expectation value surface relating to a market asking price of MB C 220 CU STW 5d type passenger car in middle-August 2003.

FIG. 3 is a flow diagram illustrating one embodiment of a modeling method in accordance with the present invention.

FIG. 4 is a flow diagram disclosing a more detailed view of the embodiment of the modeling method in accordance with the present invention.

FIG. 5a illustrates one embodiment wherein the modeling method in accordance with the present invention is used to provide comparison or other analysis data in the context of second-hand vehicle sales.

FIG. 5b illustrates a view produced by the embodiment of the present invention for assessing one's stock and associated price deviations relative to others' supply.

FIG. 5c illustrates another view produced by the embodiment of the present invention for assessing one's stock.

FIG. 5d illustrates a further view produced by the embodiment of the present invention for visualizing and comparing price levels between different parties or locations.

FIG. 6 illustrates another embodiment of the present invention wherein optimization of a dealer's car pool is performed between different outlets and optionally to/from the wholesale market or private customers.

FIG. 7 illustrates a further embodiment of the present invention wherein target group selection for direct marketing purposes is cultivated by utilizing the modeling principles according to the present invention.

### DETAILED DESCRIPTION OF THE EMBODIMENTS

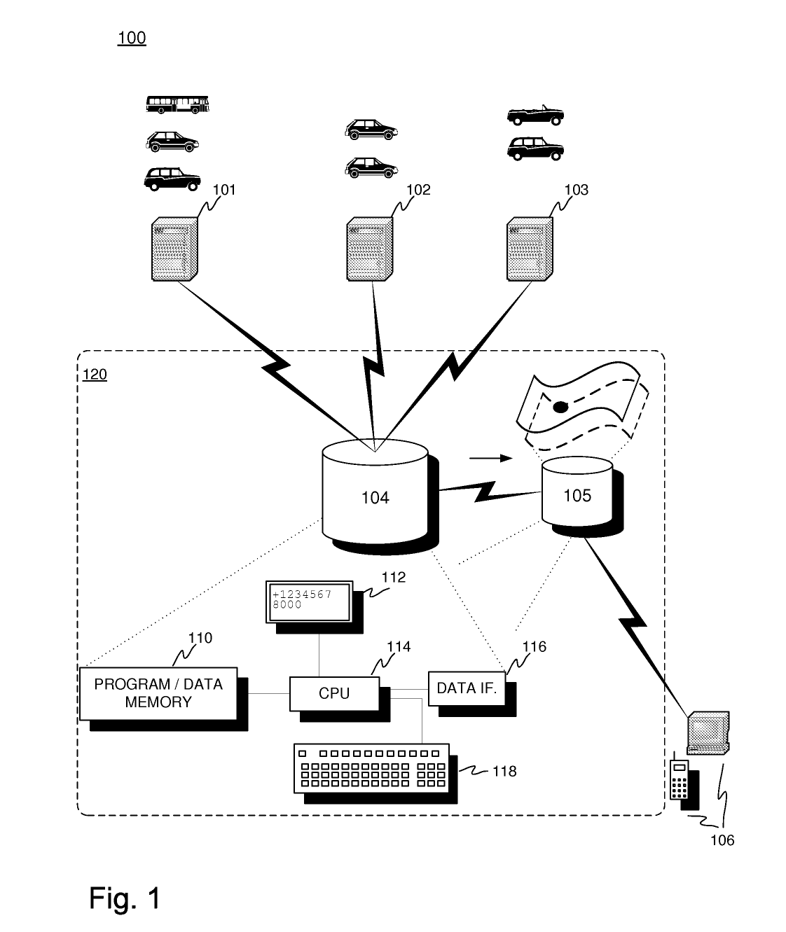

FIG. 1 visualizes an example 100 of a system for determining a value estimate, e.g. asking or running price, of various objects on a basis of available sample data. The example shown relates to vehicles, but various embodiments may as well relate to other equivalent objects available for trade. Reference numerals 101, 102 and 103 refer to input sources. The input sources 101, 102 and 103 can be located remotely from a central first database 104. The remote input sources 101, 102 and 103 input various data relating to the objects being characterised. Dotted line 120 surrounds entities that are, in one embodiment, at least logically located together to form a server side of the system including first and second databases 104 and 105. Such databases 104, 105 are managed and accessed via suitable interfacing 116 (e.g. wireless or wired data interface such as a network interface), memory 110 and data processing 114 (e.g. one or more processors, microcontrollers, DSPs, programmable logic chips, etc) means. Local UI 112 (e.g. a display) and input means (e.g. a keyboard, keypad, mouse) 118 may also be available for enabling local control of the system.

In an embodiment, the remote input sources 101, 102 and 103 represent vehicle dealers such as car dealers. From a technical standpoint the illustrated remote input sources 101, 102, 103 may specifically refer to data systems of the aforesaid dealers enabled and/or configured to communicate over available communication means with the first database 104 that may be thus considered as a central database collecting information from a number of remote entities. The sources 101, 102, 103 may be located in various different geographic locations, even in different countries. The sources 101, 102 and 103 may provide time dependent (e.g. timed) updates of locally gathered data into the first database 104. Such data include vehicle specifications (type information, variable values) and pricing information available at the source systems.

The remote input sources 101, 102 and 103 may provide and update the data of the first database 104 in a timed manner and/or upon local/remote data transfer and/or update request, for example. The remote input source 101, 102,103 and the first database 104 are preferably coupled with each other over a network connection. For example, the Internet or some other IP based connection can be used in coupling the remote input sources 101, 102 and 103 with the first database 104. Wireless connections can likewise be exploited. The first database 104 collects various data relating to the objects being characterized. Further embodiments of such data are provided hereinafter in connection with the description of the related functionalities of the system.

In an embodiment the first database 104 comprises so-called ‘raw data’ material received from the remote input sources 101, 102, and 103. In various further embodiments such raw data includes individual indications of various objects and their variable values, but as such the raw data do not yet determine a feasible model for reliably and freely estimating an expectation value of one or more random variables (dependent variables), e.g. a value estimate (running/sales/asking price) of a particular individual car, from a number of other random variables (explanatory variables), e.g. ‘specs’ (mileage, engine type, etc) of the car. In vehicle industry and trade the number of variables affecting the sales value is intuitively so huge that it is relatively difficult to evaluate or characterise a particular object purely on a basis of the raw data. However, the raw data still advantageously comprise information relating to and characterising the objects, although it is not a trivial task to retrieve a proper model out therefrom. The first database 104 may be relatively large in terms of bit size in order to store enough data.

Yet, referring to embodiments of FIG. 1, the system 100 also includes a second database 105. The second database 105 is at least functionally coupled with the first database 104 such that information may be transferred at least from the first database 104 to the second database 105. It should be noted that there can be two or more databases in the various systems and it is not vital how many physical databases there really are as long as in the logical sense both the raw data in the first database 104 and the second database 105 are provided. It is also noted that even a single database can alternatively be used as long as the two entities 104 and 105 can be logically or functionally, i.e. data-wise, separable from each other.

The second database 105 comprises modeling information, which may be represented e.g. via different expectation value surfaces as depicted in the figure via contour lines and a single target location on one of the surfaces in a form of a dot, as determined on the basis of the raw data. The second database 105 may thus comprise data logically establishing at least one expectation value surface. The expectation value surface is established from the raw data in relation to a selected variable by the underlying model. In various further embodiments various expectation value surfaces can be thus established. As previously described the expectation value surfaces determined by the model to be reviewed hereinafter are advantageously utilized for characterising the objects. The system 100 of FIG. 1 preferably comprises an element (not shown) for establishing the expectation value surfaces.

Further, the system 100 of FIG. 1 has another element (not shown) for updating the second database 105 on a basis of the first database 104. Advantageously in a further embodiment the system is substantially real-time functional and said element may update the second database 105 by revising the underlying model for example on hourly, daily, weekly, or monthly basis. Therefore the second database 105 contains in practical circumstances near real-time information and e.g. various expectation value surfaces can be constructed for characterising the objects. There can be various timed periods of updating in addition to non-timed (for example event-triggered) updates. In any case, the second database 105 can thus obtain an updated model with updated expectation value surface(s) on a timely basis. This is advantageous because the remote input sources 101, 102 and 103 can independently provide the first database 104 with various data updates or amendments, which affects the model. The first database 104 may thereafter submit the updated data collectively or in parts to the second database 105, for example. The system 100 can establish one or more expectation value surfaces on a basis of the collective update data and optionally store them in the second database 105. Characterization of the objects is thus easily obtainable. Advantageously, the execution time needed for obtaining the result can thereby be reduced considerably as model parameters (and thus related expectation surfaces) are not always calculated from the scratch whenever a party, hereinafter a “user” or a “client”, wants to access the service offered by the system for assessing the objects.

Still with reference to the embodiments of FIG. 1, a terminal 106 of the user, e.g. a computer, a mobile terminal, or a PDA, is functionally connected to the second database 105. The terminal 106 can be coupled by the Internet or IP based connection or the like. Also a wireless connection can be used. The actual query can be performed from the terminal 106 as defined by the user. The user can query desired characteristic(s) of objects by entering a corresponding query on the terminal 106 or some other apparatus providing the terminal 106 with such information. The terminal sends and provides the query towards the second database 105. The query may be carried out by accessing the model defining e.g. the one or more expectation value surfaces. The result of the query is transmitted back to the terminal 106 from the system 120, optionally via a number of intermediate devices. The model and various expectation value surfaces the model defines advantageously result in a good approximate of the characteristics, e.g. a value estimate, of the object of the query, optionally ignoring the false or misleading variable values while still fitting those variable values provided in the query to the system/model space that are not even directly presented in the raw data of the first database 104; raw data elements are often just a small sample of the real world situation and the underlying pattern, and some sort of interpolation is required to extend the model to the whole variable value space required for providing a comprehensive model.

For example, in one scenario the user wants to know a suitable asking price for a certain target car. The user enters various variable values identifying the car like model year, mileage, type of the car (brand, model), equipment and accessories in a form of a query called herein a request. The request may also be an implicit request; for example, if the user is already associated with some personal data, e.g. preferred query parameters or information about personal vehicle stock (indeed, the user may be a dealer), stored in the system 120 such that upon log-in or other access or triggering action the system 120 may, on the basis of the data, construct a query in response to the action, such action can also be considered as a request.

The request can be accordingly transmitted to the system 120 and the second database 105 thereof. On the basis of the model a query result is generated. The result can thus be an estimate of an asking price or the like. The effective processing and technical work is done by the advantageous utilization of the model that can be illustrated by the expectation value surface(s), for example. The result is then returned to the terminal 106 the user of which may evaluate or set a (realistic) price request for the target car.

Erroneous information (e.g. wrong parameters of an object corresponding to wrong variable values in the corresponding mathematic model) in the database information of first 104 and second databases 105 due to e.g. typing errors introduced during the information input process can be deleted or effect thereof minimized or rendered non-influenting, either prior to storing corresponding erroneous data elements in the first database 104 or defining the model of second database 105.

In further embodiments, deletion or nullification of erroneous or insufficient information can be performed by fixed or adaptive elimination, wherein on a basis of an predetermined or adaptive elimination model (e.g. filtering rules) some input data may be classified as erroneous and eliminated, which can even take place prior to storing the filtered data in the first database 104. Alternatively or additionally, while determining or calculating the model, suspiciously deviating data values or entities can be first detected and then deleted or ignored, thereby not affecting the model itself.

Correspondingly, upon receipt or, at the latest, during actual creation of the model, information conversion procedures are preferably applied to uniform the received data elements, if necessary. For example, if mileage of vehicles included in the sample data is given either in miles or kilometres, depending on the data source, it is advantageous to uniform the presentation prior to determining any empirical model therefrom. Unit conversions may be executed via tables or mathematical formulae, for example.

Concerning the general implementation, the substantially electronic system 100, 120 comprising one or more physical elements such as computers or data storage units may have a processing unit comprising at least one microprocessor (or microcontroller, DSP, etc), possibly a memory and software. The processing unit controls, on the basis of the software, the operations of the elements and the databases, such as receiving, storing and deleting data relating to the objects, categorizing the object parameters and the objects, establishing and creating the model(s) and related one or more expectation value surfaces, updating them, controlling periodic updates, etc. Various operations to be performed and means for carrying out them have been described in the examples. Generally, the systems of various embodiments of the invention can be implemented by a computer system comprising or being connected to a network, for example the Internet or the like. Software, programming means, elements, etc can be used in performing the various operations and functions of the embodiments, examples of which have been described above. Alternatively, middleware, programming logic, or circuit logic can be applied (not shown). The software may be provided as a software product on a carrier such as a memory card, a floppy disc, a cd, a dvd, a hard disk, etc.

What comes to the establishment of the actual model describing the market sample obtained via the input sources 101, 102, and 103, deviations in the market price of sales objects such as vehicles (cars, motorcycles, lorries, trucks, tractors, snowmobiles, atv's, etc) is based on the systematic and random factors. Systematic deviation arises from variations in the vehicle characteristics, sales period, and sales region, for example. Leftover deviation in the price of basically homogenous objects is caused by e.g. different pricing principles and desired profit margins by different parties, i.e. typically random factors from the viewpoint of a third party constructing a value estimation model.

At the time of creating a model from scratch a designer may have a sort of conception of variables that are significant in finding a way to statistically describe interrelationships and causal connections between various random variables such as price (or “value”), brand, model, age, location, mileage, etc. The conception may be initially generated on the basis of personal knowledge and experience, for example. Model is then defined by the selected variables and later on updated when it is realized that the remaining modeling error is not purely due to random factors but also due to yet unknown variables, so-called lurking variables, that should be thus brought in to the model in order to enhance the overall accuracy thereof.

Accordingly, the systematic deviation can be illustrated or figured out by using a function such as a price function between the characteristic group and the price group. The expectation value (eg. an average or median price) is generally a function of characteristics, such as features, type, accessories, sales moment and/or period, sales area or sales location, etc. The function may determine fairly accurately the association between the price and other parameters of the objects. The logarithmic price is a dependent variable and the variation thereof can be depicted on a basis of factors such as the location and timing of the sale, i.e. explanatory variables. The function including the dependent/explanatory variables and various parameters can be estimated in accordance with a regression model, for example. Regression analysis and resulting models are generally used to determine a first degree equation describing the empiric sample pairs of the variables with maximal fit.

The estimated model may be constructed as follows:

$$Log {P}_{i} = α + {\sum }_{k = 1}^{K} {β}_{k} {x}_{ik} + {ɛ}_{i} = α + {β}_{1} {x}_{i 1} + … + {β}_{K} {x}_{iK} + {ɛ}_{i} , \\ i = 1 , … , n , \qquad ( 1 )$$

wherein LogPᵢ is a logarithmic price, the dependent variable. Variables x₁, . . . x_{K} are thus explanatory. Index i refers to the number or index within the data, wherein there are n observations. Term εᵢ refers to a random error term, which is a part left unexplained in the variation of the explanatory variable due to true random factors or the aforesaid lurking variables. β:s are parameters of the model (not parameters/characteristics of the individual objects, i.e. not variable values such as vehicle brand or mileage) to be estimated. Instead of logarithmic version, also other mappings (square root, cubic root, more complex functions, etc) can be used in the model as desired. Correspondingly, instead of, or in addition to, a basic regression model, also covariance models or mixed models can be utilized as estimation techniques.

The brand, type and technical features such as engine power, body type, drive type (front, rear, 4-wheel), fuel type, engine size, gearbox, equipment/accessories, etc, and, of course, the age of the car (which may also be indicated as “model year”), usage kilometres or miles (˜mileage), sales region, sales period, and many interactions of these and derivative variables may be used as explanatory variables, for example.

Generally within the input data there is a small amount of erroneous information, as mentioned hereinbefore, wherein the age, mileage, type of the car or e.g. price are erroneous. These erroneous data are pursued to be reduced to some extent beforehand because they can disadvantageously skew the price expectation value surfaces and the model itself. Erroneous information can be tracked down by threshold comparison-type tests between input values and allowed values, or by comparing the input values with data available in the used type register (type register may be locally available at the system 120 or be considered as one of the input sources), for example.

It should be noted that the deviation between actual prices and the estimates do not indicate presence of an error in the value evaluation model. Identical products may always be priced differently by different sellers. Thus the main reason for differencies are due to the homogenic dispersion of the price among different parties. The individual prices establish a distribution around the average expectation value of the price.

The statistic model can be estimated by defining parameters by which a quadrature error (sum) is minimized. Thus the result is ‘best fit’ for prices in the source data of first database 104. When the parameters have been estimated, the estimate of the regression model can be calculated in accordance with the parameter estimates and variables as follows:

$$Log {\hat{P}}_{i} = \hat{α} + {\sum }_{k = 1}^{K} {\hat{β}}_{k} {x}_{ik} , i = 1 , … , n \qquad ( 2 )$$

In the formula (2) Log \hat{P}ᵢ is a logarithmic estimate for the price of car with running number i. \hat{β}₁, . . . , \hat{β}ₖ are parameter estimates, thus estimates of the influence of various factors on the dependent variable, i.e. the log price. When features (variable values for the formula) xᵢₗ, . . . , xᵢₖ of the target car are obtained (model, type, year, kilometers, and various other interactives or derivative variables thereof), a precise and absolute expectation value with even several decimal accuracy may be advantageously calculated on a basis of the above formula.

An estimate of the price can be obtained from the log price on a basis of the exponential function, which is an inverse function of the logarithm simply as follows:

Price estimate=exp(\hat{y}ᵢ)=e^{ŷ}^{ᵢ} (3)

The above result is a ‘point-estimate’ of the price. In practice due to the price deviation of the homogenous products such an estimate is not perfectly precise, but the estimate has distribution and variance. If the prices deterministically followed a certain formula, there would not be any uncertainty. However, this is not the case in real life, for example due to the market economy, as precisely identical cars may have totally different prices as explained hereinbefore. A ‘standard error of prediction’ depicts how great the uncertainty in determining the expectation value of the price is.

The expectation value of the price can be determined more accurately than a single price. Thus the variance of single prices is greater than the one of the estimated average. For example, let us have a look at an example wherein the average height of 50 adult males is determined. By this sample, the average height of the whole population can be estimated. Such average height can be, on the basis of the sample, determined much more precisely than a height of a randomly selected male. Similarly, an expectation or average value for the price of a vehicle is easier to determine than just a single price on the market.

The estimates produced above (formulae 2 and 3) are based on the presumption of unbiasness:

E[εᵢ]=0, (4)

which also indicates that the price estimates produced by the model are on average the same as “market prices” in the sample. If categorizing variables are utilized in the model, the estimates for each category in the corresponding variable correspond to the prices found in that category.

One use of the model relates to predicting market prices of a certain car at a certain moment.

Generally an increase in the amount of the explanatory variables also increases the explanatory degree of the model and furthermore decreases the error scattering. For example, if there are 10 000 observations and accordingly same amount of explanatory/descriptive variables, the correspondence is complete. Such a model cannot, however, estimate, for example interpolate or extrapolate, values between or outside the existing material. Thereby the model of various embodiments is focused not to this kind of over-parameterization, but for advantageously obtaining results outside or between the known data values. Over-parameterization can be avoided, for example, by ignoring part of the available parameters during the estimation. Alternatively, a check for a correspondence between price estimates and realized prices may be carried out.

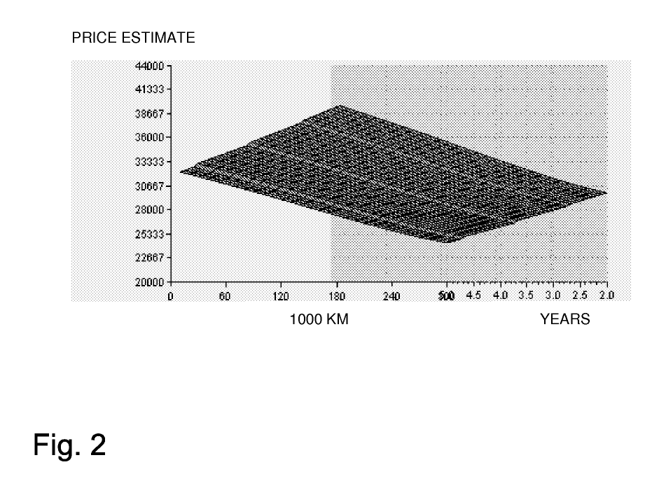

One representation of the estimate produced by the system can be seen in FIG. 2. FIG. 2 depicts an expectation value surface (2-d projection thereof) for a chosen vehicle and for a chosen dependent variable, in this case an asking price of the car, in function of the combination of age and mileage. The example relating a certain car type, which can be selected by adjusting preferred values for e.g. categorizing variables defining the type as desired, is evidently rather homogeneous because the technical characteristics of the object are the same. Therefore, foreseeable price deviation within the same type is due to the age, usage kilometres and accessories/equipment only. On a basis of a formula

$${\hat{y}}_{i} = \hat{α} + {\sum }_{k = 1}^{K} {\hat{β}}_{k} {x}_{ik} , i = 1 , … , n , \qquad ( 5 )$$

price estimates can be depicted for a desired car type with the variance of age and mileage, for example, which then converts into a representation of three-dimensional expectation value surface(s).

In FIG. 2 estimates for an asking price of a specific car type “MB C 220 CDI STW 5d” have been illustrated in a form of an expectation value surface (the situation corresponds to year 2003 scenario in Finland). The expectation value surface can be traversed through and desired points cleverly picked up (pointing certain mileage and age) for a quick asking price evaluation. The expectation value surfaces shall be reviewed in more detail hereinafter.

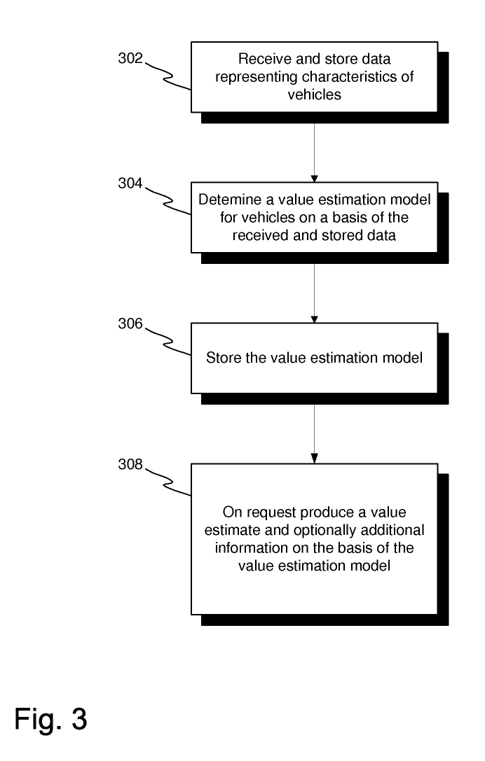

FIG. 3 discloses a flow diagram of one embodiment of a method in accordance with the present invention. In step 302 the system 120 receives and stores data relating a plurality of objects such as vehicles on the basis of which the value estimating model is constructed. In step 304 the value estimation model is created as described in this text, for example periodically or upon explicit instruction to create/update the model. In step 306 the model is stored, for example parametrically. Step 308 refers to a situation wherein a user of the system provides a request identifying characteristics of an object, or a plurality of objects, for which he wants to receive a value estimate. The value can be represented as an asking or sales price, for example, wherein the selection of the representation method most logically corresponds to the value information given in relation to the objects forming the sample database. The characteristics of the target object are input to the model and a value estimate is obtained as an output. Further analysis data such as information for facilitating comparison between several objects may also be obtained.

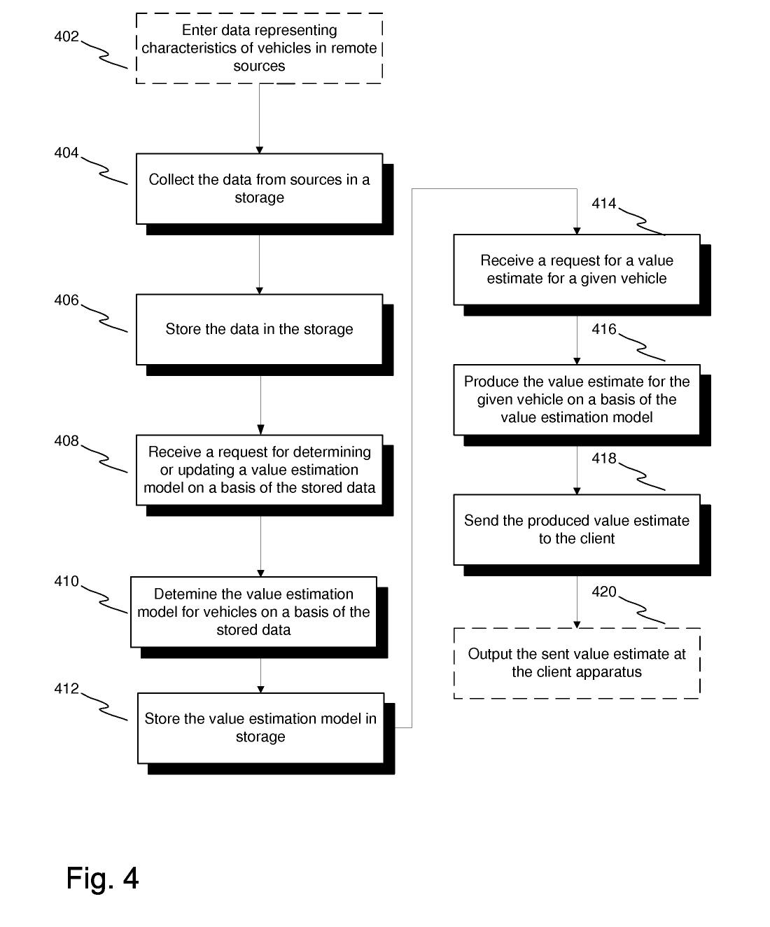

FIG. 4 discloses a more detailed view of the above method in accordance with the invention. The example of FIG. 4 discloses, in addition to system 120 tasks, also measures taken by the data sources 101, 102, 103 and user 106. In step 402 the remote input sources, e.g. car dealers 101, 102, and 103 in the context of pre-owned cars' trade, first locally acquire data about their stock and valuation (e.g. asking prices) situation. Such information is nowadays typically readily available in computerized accounting/sales systems. Then the sources 101, 102, 103 transmit the data towards the service system 120 that receives the data 404, executes optional filtering and data conversion procedures thereto, and stores 406 at least the filtered/converted data in a first database 104. In step 408 the system 120 is either triggered by a local timer or an external entity to create/update the value estimation model. In step 410 the model is created/updated and in step 412 stored in a second database 105. In step 414 the user 106 generates a query and transmits a corresponding value estimation request to the system 120, said request including necessary details for running the model. The system 120 receives the request and optionally verifies its validity and/or user's 106 entitlement to utilize the system 120. Next, the system 120 calculates the value estimate in step 416 by the model that applies e.g. age, location, and mileage information as explained herein. In step 418 the value estimate is transmitted to the user 106 either in a default form (e.g. SMS/MMS message, e-mail, predetermined database format, PDF, HTML) or in a supported alternative format preferred by the user 106 and indicated by the request or e.g. user-dependent service registration information available at the system 120. In step 420 the value estimate is outputted at the user 106, e.g. via a display.

It should be noted that the inventive system 100, 120 of the various embodiments does not necessarily determine or even visualize the value estimate graphically. Various embodiments still advantageously utilize a parametric (e.g. numerical) representation of the model that may be visualized via expectation value surface(s), for example. By analyzing the surfaces one can easily and quickly inspect the value development in relation to other changing variable values. However, the calculation of the average for each object such as vehicle/car type with various combinations of age-mileage values can be avoided. In practice this kind of estimation would be near impossible to perform as there are e.g. about 20 000 different types of cars (depending on the type register used and local market; e.g. one ‘type’ may be defined via a plurality of values of categorizing variables) and accordingly, a considerable number of variable value combinations per each type. Thereby a true average etc could be calculated only from a small portion of the whole car pool. The estimation methods of the various embodiments disclosed herein advantageously solve or at least alleviate such problem.

Namely, in various embodiments calculations are not necessarily performed independently for each car type concerning e.g. the effect the mileage has on the value estimate. Advantageously the estimation can be performed more generally by examining which characteristics together with mileage shift the value estimate. Thus various embodiments determine different mileage effect factors for groups of cars instead of single cars (or car types). Various embodiments may utilize e.g. different brands and fuels as a distinguishing factor. For example, the effect of mileage is smaller with diesel cars or with cars having a larger engine. As another example, between different brands also the effect of mileage changes.

Thus the geometry of the expectation value surface (e.g. steepness with respect to age and mileage) depends on the characteristics of the vehicle. It is formed in accordance with the data input so that a group of expectation value surfaces results in good fit with real values, thereby also being able to extrapolate the near future trends.

Regional effect can be taken into account in a variety of ways. In one embodiment the regionality is included in the model as a categorizing variable. In another embodiment the regionality is implemented via regional correction factors.

Accordingly, estimates for comparing average price levels between different regions can be obtained whilst the other factors of the applied model remain unaltered.

Percentual and log-difference have a following relationship:

Percentual effect=100*exp(Log−effect)−100. (6)

Thus e.g. Log-effect 0.1 relating to a certain area compares with 10.5% higher price on that area in contrast to the overall average price.

In this embodiment it is assumed that notwithstanding the car type and specifications the regional differences in vehicle valuation, i.e. pricing, are static between regions. This is not always the case as the regional effect may be itself dependent on various other variables such as age and/or distance driven. Therefore, in another embodiment the regional effect can be modelled with increased precision, yet not leading to a situation where a fully independent pricing model would be determined for each region, because the latter technique would require enormous amount of processing and sample data to avoid results becoming stochastic; there would be no necessary number of observations available relating to certain car brands and models for smaller regions (single retailer, etc).

Regional price differences would, in many cases, be advantageous to model utilizing a technique that still enhances the modelling result while it utilizes less parameters to be estimated in contrast to a considerable number of fully independent models.

The regression model described hereinbefore contained an error term (see formula 4) that should represent white noise in case the residual error has no further explanatory variables hidden therein. Nevertheless, it was found that in most cases by suitable interaction between regional information and car properties the error could be minimized further, i.e. the residual was not pure white noise.

Although the exemplary regression model was linear (in relation to the input parameters), there's no reason to presume that the interactions between age, mileage and region, for example, are linear. Instead, a polynome approximation, a so-called spline function, changing at selected junction points often called knots, can be exploited.

E.g. two knots may be located at regional percentual points corresponding to 15 and 75 percent in such a manner that Age_p15(a) relates to a region a so that 15% of the cars on that region are younger than Age_p15 indicates. Respectively, Age_p75(a) indicates age so that 75% of the cars of the region are younger. Each region preferably has its own knots.

Now, age-related spline variables can be defined as follows:

Age1P2=(Age>Age_{—}p15)*(Age−Age_{—}p15)². (7)

The above variable gets value 0 as long as the age<Age_p15 and for other values of the age the variable corresponds to the age exceeding the knot value to the power of two. The curve has a linear start but at point wherein 15% of cars are younger, a second degree term is added thereto. Thus for young cars the interactions between region and age plays no (at least, major) role, which is also intuitively logical as new cars are often rather homogeneously priced. Accordingly, the second spline variable can be defined:

Age2P2=(Age>Age_{—}p75)*(Age−Age_{—}p75)². (8)

Thus the resulting curve would first start as a straight line, then convert into a first second-order polynome approximation at the first knot and further to a second second-order polynome approximation at the second knot. The resulting curve is thus continuous and differentiable also at knots.

Correspondingly, spline variables (p15 and optionally also p75) for mileage can be defined.

The regional distribution of data is not always uniform as described above; there is only a small amount of data available at certain regions, which would lead to somewhat stochastic analysis results. One way to overcome this is to model an individual price level for each region but estimate the interactions between age, region, and distance driven in more coarse manner, for each greater region. The number of parameters to be estimated (and required processing) is thus reduced, and there will be enough data to enable modeling with reasonable precision.

For example, if there are 18 regions and 7 greater regions, the number of parameters to be estimated could be calculated:

2*18+G*7 (9)

deduced from a more generic formula 2*O+5*P wherein O is the number of regions and P is the number of greater regions. Multipliers 2 and G result from the time period split into two parts and the number of parameters to be estimated per greater region, respectively.

One example of a regression function for estimating, in relation to a region a, deviation from the overall average price level is formed as:

$$log A ( {X}_{i} ) = {\sum }_{a = 1}^{O} {α}_{a} * {AD}_{ai} + {\sum }_{a = 1}^{O} {β}_{a} * {Old}_{i} * {AD}_{ai} + {\sum }_{A = 1}^{P} {b}_{A} * {Age}_{Ai} + {\sum }_{A = 1}^{P} {c}_{A} * Age 1 p {2}_{i} + \sum {d}_{A} * Age 2 p {2}_{i} + \sum {e}_{A} * {Km}_{i} + \sum {f}_{A} * KM 1 p {2}_{i} + \sum {g}_{A} * KM 2 p {2}_{i} + {ɛ}_{i} \qquad ( 10 )$$

In the above formula i corresponds to a sample number, a indicates the region in question, A indicates the greater region in question, P refers to the number of greater regions, ADₐᵢ is a regional pointer variable receiving 1 if sample i is on the area a and 0 otherwise. Old is a pointer variable receiving 1 if the sample is older than 30 days or other desired period, for example. For example, data used for the function is generally advantageously from 60 days period. αₐ alone describes how much the price level of region a diverges from the overall average based on zero age and mileage during the last 30 days. αₐ+βₐ, for its part, tells how much the price level of region a diverged from the overall average earlier, e.g. in this particular example 31-60 days ago. βₐ therefore describes how the difference between region a price level and the average has changed from a period to another. In this example the value of G would be 6 (b, c, d, e, f, and g), but in one alternative embodiment, a mileage junction point could be removed, resulting in G valued as 5, without necessarily heavily affecting the modelling accuracy, which would then lead to a reduced number of 71 parameters in total according to formula 9.

Measuring price levels separately for the last period, e.g. aforesaid 30 days, ensures that the log-difference between the prediction result and prices from the sample space has a zero average for the last 30 days, i.e. the estimates for the log-price are unbiased in relation to the data samples of last 30 days. For estimating other parameters, data from a longer period can be used to obtain stable results.

When analyzing certain market and e.g. average asking prices, a proper result can be obtained by concentrating on the cars priced during a predetermined period, e.g. 30 days. On the contrary, one could analyze cars that were on sale, necessarily not priced, during that period. Such method is, in reality, more or less biased, because cheaper cars are typically sold faster than more pricey ones that thus remain for sale longer. As a result, cars having a heavy price tag end up affecting and biasing the value estimation result more, which respectively raises the estimated average prices.

The regional correction may be integrated into the overall price estimation model (equations 1 and 2) or used for explaining the corresponding residual, the “random” error. The remaining question is how to correct the price estimate to obtain unbiased results in relation to each region and varying feature combinations of the cars for sale.

A regional price function can be defined as:

log PÂ(Xₐᵢ)=log \hat{P}(Xₐᵢ)+log Â(Xₐᵢ) (11)

wherein log PÂ(Xᵢₐ) is a regional, logarithmic price estimate for a car i having a feature vector X=(x1, x2 . . . , xp). The car is located on a region a, which resides within a greater region A. log \hat{P}(Xₐᵢ) is the overall price estimate covering all the regions whereas log Â(Xₐᵢ) is a regional correction factor.

Another option is to include, as mentioned hereinbefore, the regional variables in the actual price model. This way determining the overall price estimate gets a bit more complicated as parameter estimates shall be determined in relation to each particular region.

One may further consider what the regional correction factor function shoud be like to produce unbiased regional price estimates on each area and per each car type/sub-group.

Yet as a further modeling feature, the regional effect may be limited in connection with specific variable values, e.g. particularly high mileage and age values, because flexible function forms utilized in the invention may behave unexpectedly in border areas wherein the amount of sample data is not adequate, e.g. in the context of particularly old and/or much driven cars. The limitation can be introduced by applying a certain age variable value Age_P98 for cars that are older than 98% of all cars in the sample data. For mileage, a corresponding limitation can be set. Such limits are preferably determined for each region separately as age distributions may differ significantly between different regions. For example, in more wealthy regions the cars may be younger and/or less driven than elsewhere.

Next, few more hands-on examples of the applicability of the invention in the context of vehicle, especially car, sales are presented. Data input sources include e.g. a selected type register and price information (e.g. asking prices). The type register can be used to validate/match the obtained price information with detailed type information so that the input data for the model is complete and correct. The type register classifies the cars into homogenous sub-sets and includes information such as car brand, model, generation, etc. Commercial type registers are available and produced by CAP and JATO, for example. Within one type the cars are somewhat similar and differ possibly in minor issues such as color, equipment, etc. By utilizing a detailed type register the quality of other input data can be improved instead of purely exploiting data manually typed in by a plurality of car salesmen and thus possibly including defective information.

Variables of the model (see e.g. formulae 1 and 2) can be then defined as follows:

Log P=Modelgeneration Category Gearbox Enginesize Modelyear Age Mileage Fuel Fuel*Mileage Enginesize*Mileage Brand*Mileage Power Weight width Consumption Drivetype

Such model could be of covariance type including a plurality of categorizing variables (bolded) and also several continuous variables (e.g. Age, Mileage, and Enginesize), for example. Further, the model may include derivative variables defining a combined effect of several variables, see e.g. Fuel*Mileage and Enginesize*Mileage in the above variable list.

Inso far as only one explanatory variable was utilized in the model, being e.g. the model generation, the price estimate would equal the price average of the cars of the same model generation in the available input data. Now, if more variables, such as mileage, is added to the model, they will explain the price variation within each model generation; e.g. when analyzing two cars with 50 000 km and 200 000 km on the clock, expectation value for the price of the car with the latter mileage would be lower.

As a result of model estimation, a plurality of parameter estimates for the price equation is obtained and stored (e.g. in a computer-readable file).

Parameters can be then pre-calculated for each type in the type register, provided that there's enough data available for such estimation (e.g. data related to few vehicles only do not generally enable reliable estimation). Hence, the types in the type register are modelled price-wise via a parametric mapping that converts e.g. age and mileage into a price estimate. By varying the values of age and mileage variables, an expectation value surface of the price is obtained for each type. Variable values that vary within a type and per each car entity, e.g. age and mileage, cannot be fixed beforehand. Variables such as model generation, body category (e.g. coupe, sedan, SUV, wagon), gearbox (manual, automatic, etc) and fuel (petrol, diesel) remain constant within a type definition of this example; therefore they can be determined at an early stage for future use.

Let us now consider a model comprising the following variables:

Log P=Modelgeneration Age Mileage Enginesize Diesel*Mileage

For a certain exemplary car model, the parameter of the Modelgeneration variable is, as calculated on the basis of available data, set at 9.5 and the parameter of the Enginesize variable is set at 0.0003.

Thus an expectation value surface for the cars of that model generation is obtained with a constant 9.5+0.0003*Enginesize. Concerning a car within the model generation having a 1600 cm³ engine, the constant is 9.5+0.0003*1600, which equals 9.98.

Accordingly, a price estimate for this car type with the age of 0 and mileage of 0 km/miles is exp(9,98)=21590 price units.

If the Age variable has a parameter value (i.e. multiplier) −0.08, Mileage variable has a parameter value −0.00095, and Diesel*Mileage has a parameter value +0.00025, the price of the car will decrease 9.5% per 100 000 mileage units (e.g. kilometres), except for diesel-engined cars for which the Diesel*Mileage correction factor will finetune the reduction to 7%.

Accordingly, an expectation value surface for a car belonging to the above model generation and having 1.6 litre petrol engine can be described parameter-wise as:

### Constant=9.98

### Age=−0.08

### Mileage=−0.00095

And for the 1.6 litre diesel car:

### Constant=9.98

### Age=−0.08

### Mileage=−0.0007

Thus the mileage effect differs from a corresponding petrol-powered car.

For a 1.9 litre diesel car the parameters are:

### Constant=10.07

### Age=−0.08

### Mileage=−0.0007

From the above parameters a price multiplier file can be formed, including a separate parametric description (in relation to age, mileage, and price coordinate system, for example) for each car type. If modelling data does not include enough examples of a certain type, the parameters can be interpolated/extrapolated from the parameters of neighbouring (according to predetermined criteria) types.

Also other parametric descriptions following the above logic but including more/more complex variables can be correspondingly calculated for car types in the car register.

Reverting to the embodiments disclosed hereinbefore, the selected parametric mappings can be further cultivated by transforming linear relationships (e.g. between age and mileage) into non-linear ones by utilizing splines, polynome approximation, etc. and by utilizing several parameters/variables instead of one for desired properties.

After constructing the model, i.e. determining parameters and/or expectation value surfaces, the users of the system may transmit requests including information (e.g. plate number) required for defining the target car. Based on the obtained means, the system may figure out the exact type of the car by accessing the type register, for example. If the type cannot be defined accurately enough by the given information, the user may be asked for additional information for type recognition purposes. As the expectation value surfaces have been predetermined for different car types, real-time calculations can be kept minimum upon receipt of the inquiry, and a proper location as determined by target car entity—specific variables such as age, mileage, etc, on a corresponding type-specific expectation value surface can be found out fast. The system may perform a plurality of simultaneous queries with reduced load. Age, mileage, equipment and sales region belong to the variables that are typically specific to each individual car entity, not to each type; therefore their effect on the price cannot be pre-determined on a type level.

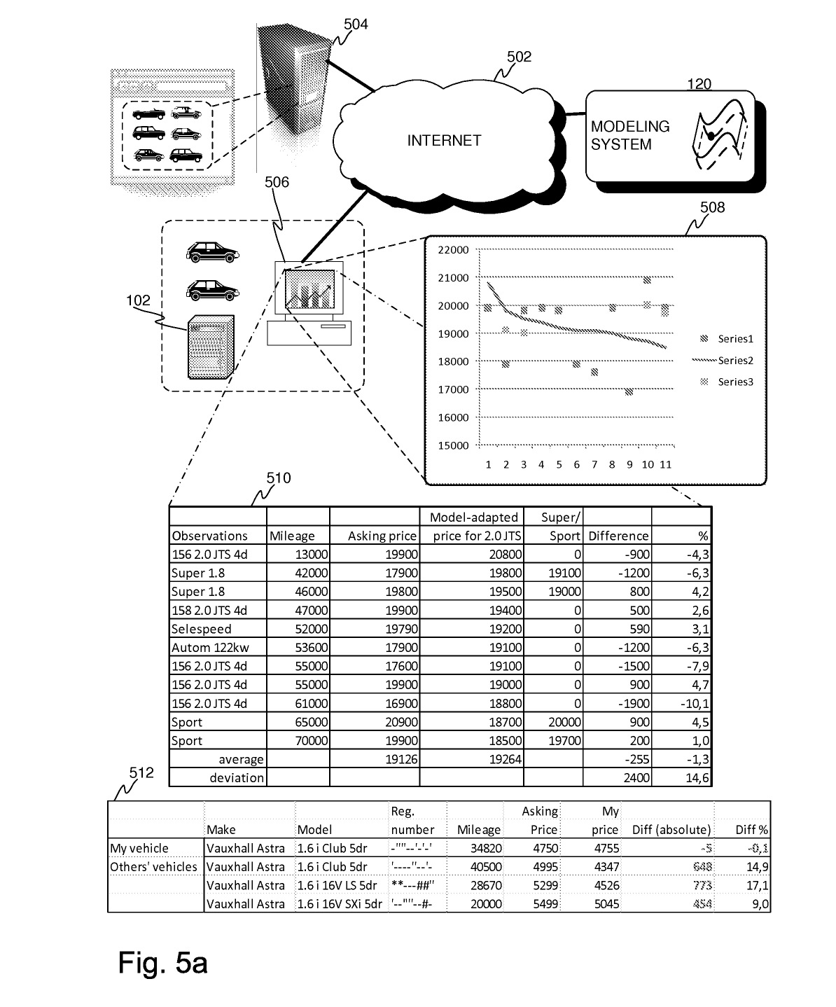

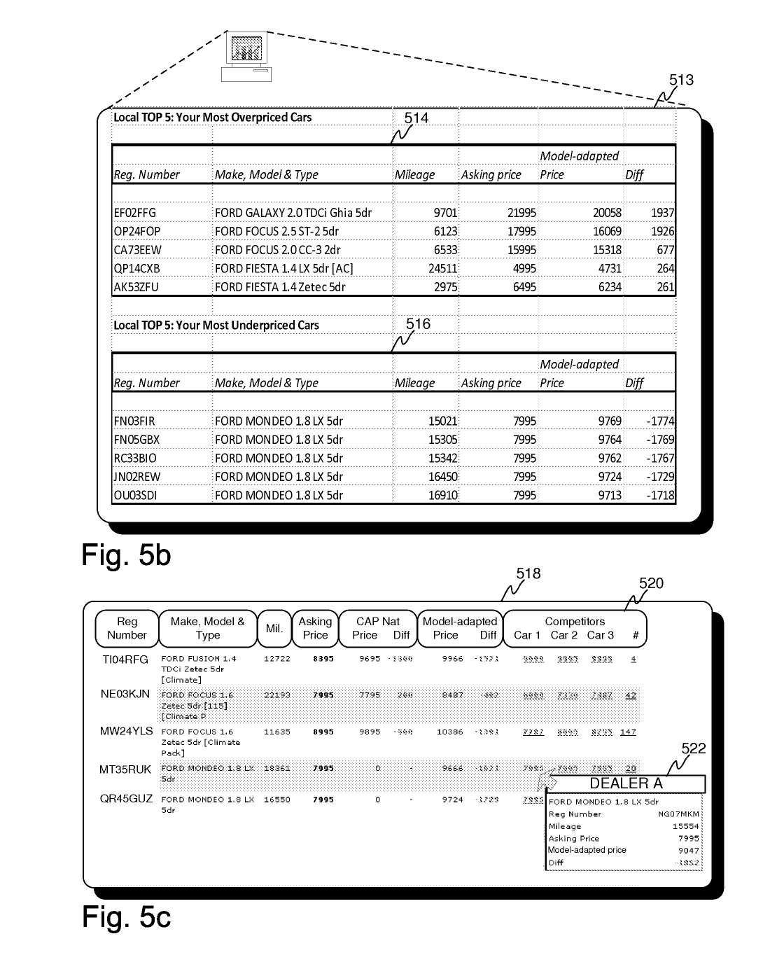

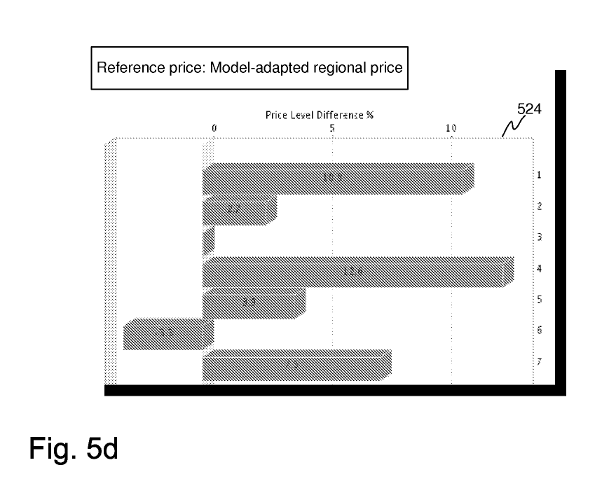

FIG. 5a illustrates an embodiment of the present invention wherein the modelling method in accordance with principles seth forth hereinbefore is applied to provide comparison and/or other analysis data in the scenario of second-hand object, e.g. vehicle, sales. Such data may be used to facilitate sensible pricing of the vehicles when buying or selling them relative to different contexts.

In this exemplary embodiment, user 506 such as a car or some other vehicle dealer (optionally one with an input source 102), a representative of a dealer chain, or other type of a user like a private person, may access, by e.g. a communications terminal, a network service 504 such as a sales portal or a specific analysis service through an available communications network 502, e.g. the Internet, for inspecting vehicle entities that are listed, on sale, and/or advertised via the service 504 by a number of parties. The user 506 may construct a selection of one or more interesting target vehicle entities listed on the service by e.g. point-and-click type actions via the service UI, for example. The selected target vehicles may belong to the stock of the user's own vehicle chain/outlet and/or to the stock of selected competitor(s) or partner(s), among other options. Alternatively, the user 506 may generate a listing of locally available target vehicles, e.g. vehicles remaining at the user's 506 stock but not listed on the service 504, with information about associated variable values instead of or in addition to accessing vehicles listed on the service 504 and utilizing the already input data. Such local listing may be utilized as a selection itself and transmitted to the service 504 for analysis. As one option, an initial selection of vehicle entities may be done automatically upon accessing the system, for example, based on the log-in or other identity information input by or at least associated with the user 506; the user's current stock or other (on-line) available vehicle list may be used as a selection. Such log-in or other action may be considered as a request for one or mores value estimates from the service 504 and associated modeling system 120 as set forth hereinbefore.

The selection may thus include information relating to a number of vehicle entities that are associated with specifically selected variable value information, i.e. values or value ranges, such as type information, mileage, age, an asking price or another indicator of estimated monetary value, etc. The modeling system 120 may be then applied to produce model-adapted value estimates for each vehicle entity so as to enable objective analysis of e.g. the asking prices against statistically produced value estimates, for example.

The operation of the service 504 and the actual modelling system 120 may be at least functionally integrated such that the user 506 may utilize both network entities 504, 120 co-operatively and optionally substantially transparently via the same service UI, e.g. web browser or a specific client software, on his terminal device. The integration may take place at the service 504, at the modelling system 120, by a further entity accessible through the network 502, and/or at the user device such that information from a plurality of sources is put together as necessary. In one embodiment the user 506 and/or the network service 504 may register to the initially optional modeling service feature provided by the modeling system 120 so as to automatically or upon request receive model-adapted comparison or other analysis data from the system 120 for the selected target vehicle entities in the future.

Table 510 discloses one example of a resulting view including details of target vehicle entities as originally selected via the service 504 (on the left) and further characteristics such as mileage and asking price. A dedicated difference or “diff” field may be used to highlight the price difference between the true asking prices of the selected entities and the statistically determined prices obtained from the system 120. By the provided information, the user 506 may then more easily figure out how low/high the true asking prices of selected vehicle entities have been defined in contrast to statistical asking prices determined on the basis of the reference data, e.g. regional prices or prices adapted based on the user's own price level or selected competitor's price level. The reference data on the basis of which model-adapted prices are determined, may be automatically selected, e.g. regional prices may be provided on the basis of the location of the user 506, or the user 506 may optionally manually select the reference via means (e.g. tick box, drop-down menu, etc) provided by the UI of the service 504, for example.

In the particular example of table 510 the user 506 has been interested in certain Alfa Romeo model or type “2.0 JTS” having also two major equipment versions or “sub-models” called“Super” (initially cheaper than the standard model) and “Sport” (initially more expensive than the standard model), whereby the model hosted by the system 120 has been configured to use a number of predetermined variables and their values, or in another embodiment, optionally additional (categorizing) variable(s), to take also this separating factor into account and to determine two prices for each super/sport vehicle entity, one as if the vehicle indeed was basic 2.0 JTS, and another with appropriate sub-model correction incorporated. Generally a similar approach may be utilized for other vehicles having different versions or “sub-models” available. A value estimate depends on the properties of the vehicle (brand, model, engine), such properties possibly including equipment level, version, or other equipment-related information. Basically similar vehicles having, however, a different equipment package may obtain a different price estimate as the installed equipment often have a certain value that may be assessed. Therefore the system 120 may even be configured to determine a value estimate for vehicles the version of which is rare as the effect of additional features provided by the version in the value may be estimated on the basis of a larger group of vehicle entities. For example, analysis may be made between a larger group of similar, according to predetermined criteria, vehicles some of which having such features and the rest lacking those; differences in value estimates, e.g. asking prices, may be used to reflect the value of such features also in a wider or different context.

The user 506 has thus selected instances of an interesting vehicle model/type available on the network service 506 such that the modeling system 120 may provide model-adapted comparison or other analysis data relative to a predetermined reference group that may be determined by location, e.g. certain location (e.g. postal code and/or city) optionally with a desired radius, or a certain province, state, or other region, and/or identity of the associated entities, e.g. desired car dealer(s)/chain(s), for example. The difference has been determined in this example on the basis of the sub-model aligned price. Instead of selecting or using one common region for providing all model-adapted prices for the vehicle instances of the selection, model-adapted price may be region-specific such that each model-adapted price is determined in light of the region that corresponds to the location of the respective vehicle instance. The obtained comparison data may be cultivated further; e.g. most overpriced and/or underpriced vehicles belonging to the selection may be determined according to predetermined criteria and optionally highlighted, separately listed, or provided via e-mail, to the user 506 in order to enable making corrective (e.g. pricing) or other actions, further analysis, etc.

See FIG. 5b for illustration of a view 513 listing a predetermined number of most overpriced 514 and/or underpriced 516 vehicles in the selection (e.g. user's own stock, which may refer to a single outlet, multiple locations, or the whole chain, for example) relative to the model-adapted price, which may be the aforementioned regional price, for example. By such an illustrative set out, the user 506 may easily recognize the potential pricing problems and make corrective actions, if needed.

Both the selection of target vehicle entities and the selection of reference data for producing the model-adapted value estimates may be executed in a variety of ways, either by the user 506 or automatically. The modeling system 120 may again utilize e.g. expectation value surfaces as reviewed hereinbefore for determining model-adapted value estimates by interpolation and/or extrapolation also for target vehicle entities the real-life findings of which are otherwise insufficient or non-existent in the user's 506 stock and/or the database 104 of system 120.

In an embodiment one or more, e.g. all, vehicles of the user 506 or selected third party vehicles listed on the service 504 may be determined as the target selection whereby the reference group for modeling and producing model-adapted estimates is formed from all or all other vehicles listed on the service 504 or otherwise available to the modeling system 120. In such case the model-adapted value estimates may be nationwide, for example, depending on the scope of the service 504.

In another embodiment the model-adapted value estimates are regional estimates as provided by the system 120 and described hereinbefore.

Concerning various alternatives for reference group selection, optionally also time-related limitations may be set. For example, the user 506 may be provided with an option to determine the reference group to only include vehicles that have been priced or re-priced not longer than a predetermined time period, such as 30 days or other period supported by the model data, ago in order to omit the vehicle entities, which have been overpriced and thus remained unsold, from affecting the model-adapted price estimates. Optionally the system 120 may be configured to give less weight to older pricing information than newer pricing information. Also a certain historical time period (start instant, end instant/length) not including the present day may be determinable for reference group definition.

In a further embodiment third party vehicles from one or more third parties may be selected via the service 504 as target vehicles whereas the model-adapted prices reflect the prices the similar entities would have at the user's own 506 vehicle shop or chain based on the information about vehicle entities (on sale/sold) at the user user's 506 shop, i.e. “if in your stock, the selected vehicle entity with asking price of X euros would have an asking price of Y euros”, for example. In this scenario the modeling system 120 may utilize data specifically about the user's 506 vehicles and pricing, which are provided by the service 504 or are already available at the system 120, for tuning the model or to at least adapt the result acquired therefrom, or otherwise the user 506 should specifically provide such data to the system 120. Table 512 of FIG. 5a illustrates a scenario in which the user 506 has selected one “own” vehicle and three competitor's vehicles from the service 504 or other source. The modeling system 120 has been configured to determine model-adapted prices “My price” to indicate asking prices the others' vehicles would have at the user's 506 outlet. It shall be noticed that the real asking price and model-adapted asking price for the vehicle entity that actually is on sale at the user's 506 outlet are almost identical. On the contrary, the modeling system 120 may be configured to determine the price of the user's vehicles at selected one or more other parties such as dealers.

The model-adapted value estimate may conceptually refer to the same value estimate as the one that is available at the service 504 regarding the third party vehicle entities, such as asking price, or determine another, e.g. estimated sales price, being typically lower than the asking price, for the vehicle entities at the user's shop. The latter option requires inputting historical, realized sales price information to the system 120. The result could be used to predict how the asking prices set by others would convert into potentially realizable sales prices generally, regionally, or at the user's outlet, for example. If multiple parties provide historical information (associated time period may be fixed or adaptive such that older information is given less weight) about realized sales prices to the system 120, e.g. regional sales price estimates or related discount factors (difference between asking and sales prices) may be calculated in addition to regional average asking prices.

The user-specific, model-adapted value estimate may be formed from a regional value estimate, for example, by utilizing a correction factor or a correction function that utilizes comparison between data available on user-specific asking prices (and/or realized sales prices) and national/regional asking prices (and/or realized sales prices). This can be obtained by determining the correlation or e.g. average difference in general and/or on e.g. car brand, type, model or other variable basis between national/regional average price estimates and user-specific established prices for different vehicle entities. On the basis of such determination, more generic regional value estimates may be adapted into user-specific value estimates either generally or even brand, type, or e.g. model specifically. To concretize the potential importance of brand-level analysis, it has been found that the user such as a dealer of a certain brand may be able to close deals with remarkably higher sales prices for vehicles of that brand than for other cars or than other dealers. This also means that sometimes asking prices at one dealer may justifiably be kept higher than on average. User-specific correction factors or functions are preferably updated e.g. periodically such that possible market changes are taken into account in the estimation results.

In a further embodiment, the vehicle or user (e.g. dealer or chain) entities of the reference group may be independently selected by the user 506 such that the model is first determined based on the reference group and then used for determining the value estimates.

In an embodiment, the price list of the user's 506 current and/or past stock of vehicle entities may be compared with data available on the network service 504 so as to provide comparison data about price levels between the user 506 (e.g. one dealer/seller) and other entity/entities (other dealer(s)/seller(s)) or average, e.g. national or regional, prices. The model-adapted value estimates may be based on the price level of one or more selected competitors, for example, provided that at least some of their pricing information such as asking prices is available for analysis. The modeling system 120 may, on the other hand, handle one or more users, e.g. dealer(s) or chain(s), as a certain location or region in the model. The comparison may be conducted both on a vehicle entity level and concerning the whole stock of the user 506 against vehicle entities of other, either all or specifically selected, parties the vehicle entity data of which are available via the network service 504, for example.

For example, the cars listed on the service 504 by a certain user such as a certain car dealer or dealer chain may be compared with other entities' cars or all cars as adapted for comparison by the modeling system 120 in order to perform at least one action of the following: show similar (according to the type register and/or other, possibly user-defined, criteria) cars the others have listed, compare the price of the stock of the certain certain user with the selected or all other entities' stock optionally so as to provide price analysis information concerning the average price level of the cars between these parties, and compare the price of selected car entities against other entities' (selected or all) similar (as adapted by the model) cars in a car entity specific or type specific manner.

FIG. 5c discloses a view 518 wherein the user 506 has determined, or the service 504 has determined for him, five vehicles, e.g. his own or other, to be included in the target group selection and the system 102 has then provided associated national CAP prices (when available), model-adapted, e.g. regional, reference prices as well as at least a sample 520 of others parties' vehicles that are similar, according to predetermined criteria, to the target vehicle entities, the other parties' vehicles being disclosed in a predetermined, sorted order, which may be price-based or location distance—based order (increasing or decreasing), for example. The sample 520 may further indicate model-adapted prices 522 for other parties' vehicles such that the difference from the reference group price, e.g. regional price, may be obtained and compared with the difference between the target group vehicle and the associated model-adapted price, for example.

The analysis results such as comparison results may be illustrated via graphs 508 or bar graphs, for example, in addition to textual representation such as tables. In the exemplary graph 508 the single dots represent true prices of the vehicle entities of the selection and the curve represents model-adapted prices, i.e. reference price estimates. A reference group and associated reference level for the model and visual representation may be selected as a CAP level, the level of the user 506 (in which case the true prices correspond to others' vehicles, e.g. competitor's vehicles on sale), regional average level, general average level, etc.

FIG. 5d illustrates one option 524 for illustrating price data. Seven parties such as car dealers from a same region have been selected and e.g. predetermined one or more vehicles from their stock, or the whole stock, has been represented as a horizontal bar the length of which being determined on the basis of the price difference relative to the selected reference level, i.e. regional level in this case. In a corresponding manner, several outlets of the same chain may be selected and visualized; when the outlets are from different regions, also the outlet-specific price differences from the reference level may be determined region-specifically. Alternatively, e.g. a national or other common reference price may be utilized.

In one embodiment the user 506 may communicate with the modeling system 120 that is configured to obtain, if not locally available, necessary information required for producing analysis data as asked by the user 506, from the user 506 and/or via the network service 504. Thus the user 506 does not have to necessarily connect to the network service 504 or another intermediate entity for obtaining comparison data by the modeling system 120.

The comparison arrangements as set forth above are feasible both in sales and acquisition purposes of vehicle entities or a vehicle fleet. For a buyer the arrangement may provide a price recommendation in relation a vehicle with certain specifications, e.g. a maximum price to offer, which still seems sensible according to a predetermined criterion in light of data obtained from the modeling system 120. Such data may indicate e.g. national or regional average asking or sales price, or buyer or competitor-specific information. Further, stock status and expected demand may be taken into account in estimating a sensible purchase price as more specifically described hereinafter in connection with further, either stand-alone or supporting, embodiments of the present invention.

For a seller the information may indicate a lower limit for a sensible sales price, for example, that may be based on asking or sales price estimates obtained by the modeling system 120 and optionally adapted based on desired or average profit margin, storage costs, handling charge, further sales or repair costs, etc. In both cases, also true asking prices of comparable vehicle entities offered by other parties may be retrieved and shown to the user 506 to concretize the variance between single offers.

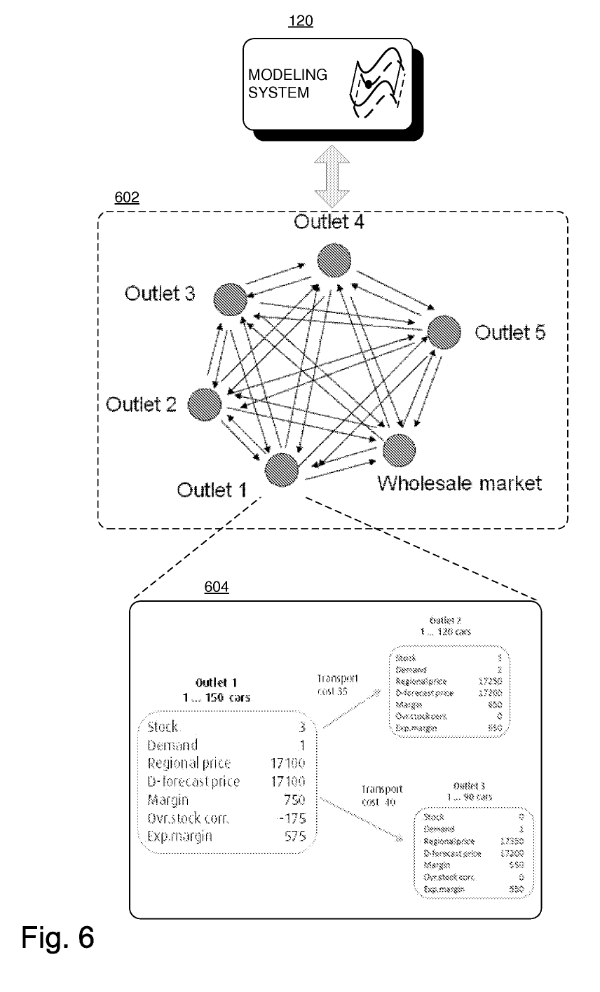

FIG. 6 illustrates another embodiment of the present invention wherein optimization of a dealer's vehicle stock or “pool” is performed between different outlets and optionally to/from the wholesale market. The outlets and the wholesale market entity are each marked with circles, and possible stock optimization actions between those are marked with arrows within 602.

The current trend in vehicle sales is partnership and fusion of single dealers into larger entities such as chains. Second-hand vehicles may be then moved between different outlets of a chain to optimize the revenue in light of the sales of the whole chain. Such aggregate approach may provide benefits such as a shortened sales periods, increased local and total profit, and smaller storage space requirements, for example. Logistics control between only two outlets and optionally to/from the wholesale market might look manageable even without analysis tools, but even in these and undoubtedly in more complex scenarios with multiple outlets, see 602 of FIG. 2, and a large number of vehicles therein, further analysis tools are valuable if not absolutely necessary aids in carrying out a rational decision-making process as a whole. For example, it may be advantageous to determine the number and/or nature of vehicle entities to be transferred between each outlet and optionally wholesale market by applying the available valuation and cost data. At 604 an example of an intermediate analysis result is shown wherein transfer of a car is considered between three locations (outlet 1 equals to the current location) with different regional price, dealer-specific estimated price, (unit or indicative) stock, (unit or indicative) demand, maximum stock size and/or other associated figures.

For example, five outlets converts into thirty single-direction transfer options provided that also traffic to/from wholesale market is considered. However, larger chains include tens or hundreds of vehicle shops in which case the number of transfer options may increase to several thousands. As stock optimization between outlets should preferably be performed whenever stock situation changes, it is clear that optimum or even just a decent solution cannot be found by mere expert consideration.

In one embodiment of the present invention the model as provided by the modeling system 120 is used to maximize the profit obtainable from selling the vehicles from the standpoint of the chain or another aggregate entity comprising multiple, e.g. five, outlets as in 602. As analyzed hereinbefore, estimated sales prices on different regions and by different dealers may considerably vary, not forgetting the wholesale market, which motivates utilizing the modeling system 120 to determine local value estimates of the on-stock vehicles of the chain so as to find the location/outlet or external destination providing expected maximal value, e.g. sales price or profit, for each vehicle. The modeling system 120 preferably utilizes data about realized sales prices in the model calculations, when available.

In another embodiment also further factors are considered when determining logistic moves between the outlets. These further factors may include, but are not limited to, at least one element selected from a group consisting of:
current stock profile, i.e. how much free space, how many similar models on sale already, storage space expenses, etc.
sales profile (e.g. what brands/models are typically sold from a particular outlet),
demand and/or expected sales period (may be dependent on the sales and/or the stock profiles, e.g. if demand is on average one similar vehicle per month and there are two already in stock, expected sales period is three months without considering further factors such as trends), and
   transport costs and optionally other location-specific costs between outlets. These further factors may be embedded in the valuation model so that they either increase or decrease the value estimate, or otherwise used as parts of an overall profit estimation calculus.

In one embodiment, if there are several, substantially similar (e.g. selected variable values remain within a predetermined range) vehicles available for sale at a single outlet, the expected sales price may be lowered according to a predetermined amount or percentage, for example. The demand, the estimate of which may be based on predicted average sales period for a vehicle entity of a certain brand, model and/or certain type according to the sales history (e.g. date of arrival vs. date of sale), optionally taking also pending customer enquiries or enquiries that could not be served into account, or be based on the outlet profile (i.e. certain vehicles shall preferably be always/never available via a certain outlet), sales trends and shifts therein (this information may be provided by e.g. market research experts), and/or seasonal variation, or any combination of the above features, for example. Yet, the demand estimate may be configured to have a predetermined, absolute or percentual, effect on the value estimate of the associated vehicle entity for each outlet, for example.

The modeling system 120 may be configured to estimate the effects of transferring one or more vehicles between different outlets of a same chain so that the overall profit for the chain and/or the selected outlets is potentially maximized, wherein for each vehicle entity the possible sales prices are estimated on an outlet basis and possible transport costs, storage costs, demand and/or sales period factors may also be taken into account and quantified either directly in the valuation or via separate profit maximization. Existing limitations such as stock (desired) maximum size, maximum value or certain outlet's commitment to trade only certain vehicle brands or types may be taken into account as edge conditions during valuation and profit analysis.

As different outlets of a chain may be physically, functionally and also at least partially financially independent units, upon moving a vehicle from an outlet to another a transport price may be determined such that both the source and destination outlets advantageously benefit from the transfer. Such transport price may be based on the difference between estimated realizable sales prices of the vehicle entity at both outlets.

In one embodiment of the present invention the vehicle pool optimization may be applied already upon acquiring a vehicle entity from a client such as a private person, whereby the current stock and/or estimated demand for such vehicle entity may be utilized as decision-making criteria, either outlet-specifically or chain-wise, for determining a sensible purchase price, if any, which may vary depending on the intended use of the purchased vehicle, i.e. is it intended/available for local (outlet-specific) sales, chain-level sales at an optimum outlet, or for direct trading to the wholesale market.

In one embodiment the modeling system 120 is configured to estimate which vehicle entities currently present in stock may be traded to the wholesale market and/or what type of vehicles could be advantegously bought therefrom. Vehicles that do not fit the sales profile or the estimated sales prices, demand and/or sales periods of which (or other characteristics) do not seem promising in contrast to other vehicle entities in stock may be advantageous to trade out to the wholesale market in order to free valuable storage space and avoid unnecessary costs from automatic depreciation effect due to the inevitable ageing of the vehicle during lengthened sales period. Vice versa, the chain or a single outlet may buy vehicles from the wholesale market based on analysis by the modeling system 120 on predicted sales prices, demand and/or profit locally obtainable in contrast to the wholesale market situation that may be different (e.g. locally higher demand of vehicles that are in a wider context not that appealing may be configured to trigger buying such vehicles from the wholesale market).

In one embodiment the modeling system 120 is provided with information on one or more entities such as leasing companies, dealers, or wholesale market (players) so as to determine optimum and e.g .direct buyer and optionally retailer for defleet vehicles, for example. Such information may include sales, e.g. volume, and price information related to vehicles bought and sold by one or more dealers and/or wholesale market such that the system 120 may suggest to a leasing company whereto sell defleet vehicle(s) with maximum or at least reasonable price and to the dealer or wholesale market wherefrom to buy defleet vehicle so that the resale profit is correspondingly optimized, by which a true win-win situation may be achieved from the standpoint of transaction parties.

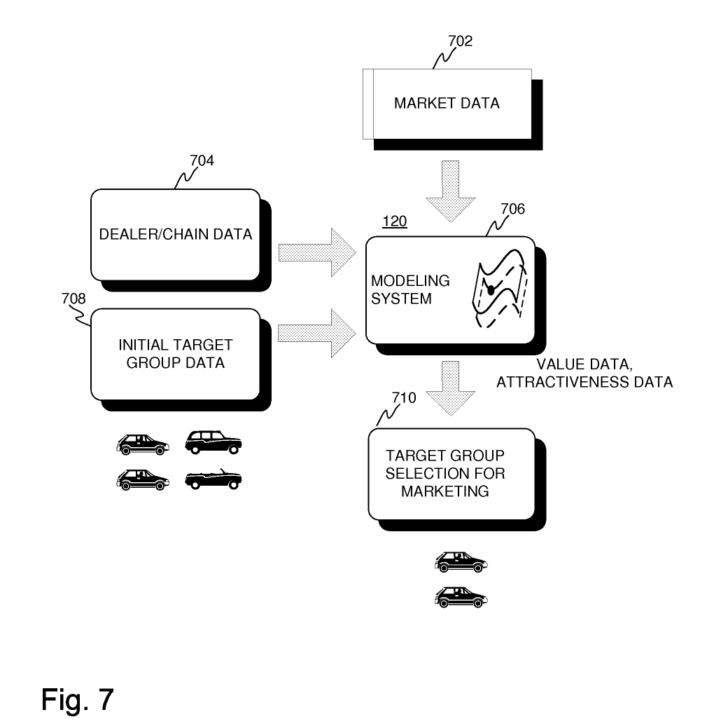

FIG. 7 illustrates a further embodiment of the present invention wherein target group selection for direct marketing purposes may be cultivated by utilizing the modeling principles according to the present invention. Currently owned vehicle entities of potential clients as determined by other means, e.g. market research, may be sorted and ranked based on their fit to the current stock of the dealer.

First, at 702, market data 702 for constructing the value estimation model as described hereinbefore may be obtained. Also dealer/chain or other entity- specific data 704 and initial target group data 708 can be provided to the modeling system 120. The initial target group data 708 may be based on vehicle owner sensitivity analysis conducted on a basis of a vehicle ownership register or a customer database and performed by a market analysis expert or by a dealer/chain itself, for example, resulting a list of vehicle entities the owners of which initially fall into at least one category selected from a group consisting of: past vehicle/usage history—based likely change of transportation in the near (predetermined period) future, one or more previous purchase(s) from the dealer, published interest, e.g. registered visit in an outlet or web page/store, in acquiring a new vehicle, residence in a predetermined region, current or previous ownership of vehicles similar to the ones currently on stock/available for sale according to predetermined criteria, or a record of an event (child birth, for example) that may trigger acquiring a new (type of) vehicle available via the dealer, etc. Accordingly, the dealer or chain-specific data may include information on brands officially represented, if any, preferred second-hand vehicle brand(s), stock situation (second-hand and/or new), sales history (price information/sales period/demand), location information, etc.

The modeling system 120 may be applied 706 to provide additional information such as estimates of possible asking and or sales prices or other variable values for vehicle entities of the initial target group data 708 based on available market data 702 and dealer/chain-specific data 704, for example. The system 120 may be configured to determine lowest tolerable purchase prices in view of the expected sales prices for the vehicle entities so as to enable picking out e.g. vehicle entities the purchase price of which could be set higher than the corresponding market average predicted from available market data, e.g. from asking, sales, or trade-in prices, due to a higher estimated resale price or a higher demand, for example, in which case the owner of such vehicle entity could be selected 710 to the final target group or otherwise marked as a preferred customer as he could be offered a good deal relative to the estimated average offerings.

Generally, the system 120 may be used to determine the target group or at least supporting information for determining the target group for marketing purposes based on one or more elements relating to the current vehicles of initial target group members and selected from a group consisting of: a value estimate, e.g. regional average, purchase or expected sales price, falling within a predetermined range, estimated profit obtained from the resale of the vehicle falling within a predetermined range (e.g. difference between estimated own sales price and market average or maximum tolerable purchase price), dealer or chain stock status, trade-in value in relation to business partners or wholesale market, vehicles in the current stock estimated as interesting from the standpoint of the vehicle owner (e.g. brand loyalty, vehicle type loyalty, vehicle age history, or mileage history, which information could be obtained from vehicle register, for example).

In the case of multiple similar vehicles already in stock, the estimated value such as a predicted sales price for an additional incoming vehicle entity could be adjusted downwards, and in case of too few current cars relative to the estimated,recorded, and/or historical demand, upwards. The same analogy may be applied in the previously described embodiments of stock optimization as well. In addition to the used vehicles, the arrangement could be used to offer new vehicles to the clients. In addition to or instead of determining vehicles, which would technically most probably appeal to the customer, vehicles available for sale for which operating costs and/or a financing solution, e.g. a monthly payment, would remain on about same level or as otherwise tolerable according to predetermined criteria and e.g. available wealthiness data, could be specified by the system 120. Such criteria may include e.g. a percentual threshold relative to a customer's wealthiness, e.g. income, thus defining an upper limit for tolerable expenses arising from purchasing, owning and/or using a vehicle for a predetermined period.

Although the description above contains many specifics, these are merely provided to illustrate the invention and should not be construed as limitations of the invention's scope. It should be also noted that the many specifics can be combined in various ways in a single or multiple embodiments. Thus it will be apparent to those skilled in the art that various modifications and variations can be made in the apparatuses and processes of the present invention without departing form the spirit or scope of the invention. The feasibility of the invention is not strictly limited to vehicles and can be used to assess other commodities as well; used variables may be then defined in a case-specific manner.

1. A computerized system (120) for assessing vehicles comprising means for obtaining (116) data, optionally from a plurality of sources (502, 504, 506, 101 , 102, 103), said data representing characteristics of a plurality of vehicles, said data including indication of a value of each vehicle and of at least one characteristic selected from the group consisting of: age and mileage of the vehicle, means for storing (104) said received data, means for receiving (116) a request for a value estimate of at least one target vehicle having a number of predetermined characteristics, means for producing (114) a value estimate for said at least one target vehicle on the basis of the data, characterized by means for determining (114) a value estimation model for vehicles on the basis of the received data representing characteristics of a plurality of vehicles, said model comprising a plurality of parameters to be determined and a plurality of explanatory variables associated with the parameters and defined on the basis of said characteristics, wherein at least one of said age and mileage is configured to affect the value estimate, the value estimate being a dependent variable in the model, means for storing (105) at least part of the value estimation model including said plurality of parameters modeled, whereby, in order to serve valuation requests said means for producing the value estimate is configured to map at least part of said number of predetermined characteristics of said at least one target vehicle, via said value estimation model, to said value estimate, wherein said system is configured to perform an action to facilitate comparison of the value estimate to other valuation information related to said at least one target vehicle or some other vehicle (508, 510, 512, 513, 518, 524, 604, 710).

2. The system of claim 1, wherein said data further include indication of a location of each vehicle, whereby the location is configured to affect the value estimate.

3. The system of claim 2, wherein regional effect in said value estimate is based on the locations of vehicles and modelled via at least one explanatory variable.

4. The system of claim 2, wherein regional effect is taken into account in the value estimate on the basis of said location via a regional correction factor.

5. The system of claim 1, wherein during said mapping a location in a variable value space is obtained by the model, said location obtained in said variable value space being indicative of the value estimate.

6. The system of claim 5, wherein an expectation value surface for a value estimate is spanned by a plurality of locations in the variable value space produced as an output of the model to the input of predetermined variable value combinations, wherein a number of variables in the predetermined variable value combinations are kept static whereas the remaining ones are traversed through in relation to their potential values.

7. The system of claim 1, wherein said indication of the value corresponds to or is based on the asking or realized sales price of the vehicle.

8. The system of claim 1, wherein said model includes at least one of the following: a regression model, a covariance model, or a mixed model.

9. The system of claim 1, wherein said action includes determining said value estimate as context-dependent, wherein said context is selected from a group consisting of: value of said at least one target vehicle as a part of or in relation to a predetermined vehicle dealer's stock comprising a number of vehicles, value of said at least one target vehicle as a part of or in relation to the stock of a predetermined vehicle dealer chain comprising a plurality of dealers, and value of said at least one target vehicle in relation to a selected region.

10. The system of claim 1, wherein said action includes at least one element selected from a group consisting of: providing or displaying an asking, purchase or sales price of the target vehicle as other valuation information for comparison with the value estimate of the target vehicle, determining absolute, parametric or relative difference between said other valuation information, said other valuation information optionally including a predetermined price of the target vehicle, and said value estimate, providing a listing of other vehicles comparable with said target vehicle according to predetermined criteria with associated pricing information, and providing information on price level difference between two entities by adapting the value estimate of the target vehicle in accordance with the price of the target vehicle at a first entity to the context of a second entity having priced one or more other vehicles.

11. The system of claim 1, wherein said value estimate is determined relative to a certain location, such as certain dealer, of the target vehicle, and said action includes determining another value estimate of the target vehicle relative to another location as said valuation information so as to enable comparing the value estimates and facilitate on the basis of the comparison determining whether a transfer of the target vehicle from the current location to said another location seems financially worthwhile or not.

12. The system of claim 11, configured to analyze and suggest potential transfers of one or more vehicles between a plurality of outlets, each outlet having characteristics affecting the value estimates, said characteristics including at least one element selected from a group consisting of: location, current size of vehicle stock, storage space, storage expenses, transport costs, sales expenses, demand, and estimated sales period, whereupon said system is configured to take said at least one element into account while analyzing and suggesting the transfers.

13. The system of claim 11, configured to analyze whether selling the target vehicle to or buying the target vehicle from the wholesale market is financially worthwhile.

14. The system of claim 11, wherein lucrativeness of potential transfers is analyzed from the standpoint of a source entity, destination entity, or aggregate entity whereto both the source and destination entities belong.

15. The system of claim 1, configured to determine a plurality of value estimates for a plurality of target vehicles, respectively, from a standpoint of a predetermined vehicle dealer or a dealer chain so as to facilitate defining one or more vehicles worth obtaining from said plurality with value estimates considered as preferred according to predetermined criteria, wherein each value estimate is created or adjusted by utilizing at least one element selected from a group consisting of: demand for such vehicle as estimated by the dealer or chain, sales period for such vehicle as estimated by the dealer or chain, number of corresponding vehicles already in stock at the dealer or chain, storage space available at the dealer or chain, and preferred vehicle profile at the dealer or chain.

16. The system of claim 15, wherein a preferred value estimate is based on fulfillment of at least one criterion selected from a group consisting of: estimated realizable sales price or sales profit for the vehicle higher than a predetermined limit, estimated sales period shorter than a predetermined limit, estimated demand higher than a predetermined limit, current stock smaller than a predetermined limit, storage space available larger than a predetermined limit, and estimated financially acceptable purchase price to a seller or trade-in customer higher than estimated average purchase price by other parties for a similar vehicle.

17. A method for assessing vehicles comprises obtaining data (302, 404), optionally from a plurality of sources, said data representing characteristics of a plurality of vehicles, said data including indication of a value of each vehicle and of at least one characteristic selected from the group consisting of: age and mileage of the vehicle, storing said received data (302, 406) in a first storage, receiving a request (408) for a value estimate of at least one target vehicle having a number of predetermined characteristics, and producing a value estimate (308) for said at least one target vehicle on the basis of the data, characterized by determining a value estimation model (304, 410) for vehicles on the basis of the received data, said model comprising a plurality of parameters to be determined and a plurality of explanatory variables associated with the parameters and defined on the basis of said characteristics, wherein at least one of said age and mileage affect the value estimate, the value estimate being a dependent variable in the model, storing at least part of the value estimation model (306, 412) including said plurality of parameters modelled in a second storage, and, in response to receiving the request, mapping at least part of said number of predetermined characteristics of the target vehicle, via said value estimation model, to said value estimate (416), wherein an action to facilitate comparison of the value estimate to other valuation information related to said at least one target vehicle or some other vehicle is performed.

18. The method according to claim 17, wherein said data further include indication of a context such as location of each vehicle, whereby the context is configured to affect the value estimate.

19. Computer software adapted to, when run on a computer, to execute the method steps of claim 17.

20. A carrier medium carrying the computer software according to claim 19.
